(19) United States
(12) Patent Application Publication
(10) Pub. No.: US 2024/0354803 A1
(43) Pub. Date: Oct. 24, 2024

(54) SYSTEMS AND METHODS FOR PRODUCT PERSONALIZATION USING GENERATIVE ARTIFICIAL INTELLIGENCE

(71) Applicant: Wells Fargo Bank, N.A., San Francisco, CA (US)

(72) Inventors: Ramesh Babu Sarvesetty, Bangalore (IN); Himanshu Baral, Fremont, CA (US); Shuvam Sengupta, Kolkata (IN); Rameshchandra Bhaskar Ketharaju, Hyderabad (IN)

(21) Appl. No.: 18/303,379

(22) Filed: Apr. 19, 2023

(51) Int. Cl. G06Q 30/0251; G06N 20/00

(52) U.S. Cl. CPC G06Q 30/0251; G06N 20/00

(57) ABSTRACT

Systems, apparatuses, methods, and computer program products are disclosed for providing a set of recommended user updates. An example method includes identifying an update event pertaining to a first user based on real-time event data and generating, using a recommendation generation model, and based on the real-time event data, a set of recommended update categories for the first user. The example method further includes generating, using a user analysis model, and based on user information associated with the first user, a set of bespoke update parameters and generating the set of recommended user updates for the first user based on the set of bespoke update parameters, where each recommended user update from the set of recommended user updates corresponds to a recommended update category in the set of recommended update categories. The example method further includes providing a recommended user update notification comprising the set of recommended user updates.

### BACKGROUND

Financial technology enabled services may be created and marketed to customers, and recommendations for these services may be based on customers' conditions, such as the current status of an investment portfolio or the stock market's performance. Generative artificial intelligence (GAI) technologies have emerged as a way to rapidly customize and create content given sufficient training data and computational power.

### BRIEF SUMMARY

Financial technology enabled services must generate personalized recommendations and/or products and services that are tailored to customers in order to appeal to the preferences of the customer. For example, current services may be limited to providing one-off recommendations and/or products based on a current status of a financial portfolio and/or the financial market conditions (e.g., maximizing returns based on the portfolio's or the stock market's performance). However, these one-off recommendations may not address a customer's actual needs and interests. For example, rather than focusing on maximizing returns, a specific customer running a non-profit organization may instead prefer to have a consistent year over year return to keep the organization healthy. Additionally, customers may feel alienated or lack connection to the services or products, which may negatively impact customer retention.

At the same time, providing a personalized recommendation for products and services may be a costly endeavor. Personalized attention from trained agents may not be scalable to the size of a company's customer base, requiring a compromise between quality of service and the size of the customer base served. To address these limitations of existing financial technology enabled services, GAI models may be used to optimize customer profiles and generate more personalized (e.g., through hyper-personalization) recommendations and/or products.

Example embodiments described herein may include a GAI model that is continuously trained to output hyper-personalized recommendation of updates, products, and/or services for customers. These hyper-personalized recommendations may be generated based on user data associated with a customer (such as, for instance, data obtained directly from the customer; data mined from public sources such as the internet including social media, personality, needs, aspiration, financial status data, or the like; data obtained using existing customer portfolio(s); data obtained from analyzing past investment records (e.g., learning investment style) and/or bucketing of individuals of similar nature; etc.). Generalized recommendation categories may be generated, then specified based on the configuration of the system to provide recommendations geared towards the overall strategy of a company, limitations and preferences of the customer, or other limiting factors.

Accordingly, the present disclosure sets forth systems, methods, and apparatuses that improve personalization of recommended updates, products, and services for customers using financial technology enabled services. The solutions described herein enable financial service providers to reduce costs associated with creating highly personalized recommendations for customers, mitigating the trade-off between high levels of personalization and maintaining a large customer base. Embodiments disclosed herein represent technological advances in the field of GAI, and use new advances in the rapidly developing field of artificial intelligence to provide improvements in financial services technology.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for product personalization using GAI.

FIG. 2 illustrates a schematic block diagram of example circuitry embodying a system device that may perform various operations in accordance with some example embodiments described herein.

FIG. 3 illustrates an example flowchart for generating update parameters personalized to a user, in accordance with some example embodiments described herein.

FIG. 4 illustrates an example personalized product payment card used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “historical user data” may refer to a data structure that is configured to describe data related to a particular user. In some embodiments, historical user data may include one or more of user browsing history, user location data history, user interactions with application prompts, or other historical user data. Historical user data may be directly collected from various applications or sites that may share data with the system, or may be obtained from shared info from a third party, accessed on a storage device either locally from or on a remote server. Historical user data may be usable for deriving information about a user's preferences for shopping, banking, or other activities relevant to the system, and may be analyzed to infer products or user updates for the user. For example, a user may communicate via social media that they have received a check in the mail, and plan to cash the check at a physical location. This activity may generate historical user data, which may be a derived form of the raw data from the social media interaction. This example historical user data may allow the system to infer the user conducts business using checks with some frequency and recommend user updates related to checking accordingly.

The term “user recommendation data” may refer to a data structure that is configured to describe data related to a set of possible user updates that may be offered. In some embodiments, the user recommendation data may refer to past or existing user updates offered by a business or institution. For example, when configured to generate payment card user recommendations, the user recommendation data may refer to a set of payment card offers including details such as credit limits, rates, benefits, and other details of the payment card plans. User recommendation data may refer to actual existing user updates, user updates determined by a user which the system is configured to process, or automatically generated user updates, which may be generated by other methods or by example methods disclosed herein.

The term “organization-level strategy directive” may refer to a data structure that is configured to describe a set of parameters guiding the generation and/or selection of user updates offered to customers or users of an organization. The organization-level strategy directive may describe or suggest high-level goals that may be realized by individual user updates. For example, an organization-level strategy directive may relate to adjusting strategy to expanding market share, which may guide the generation of user updates with lower prices, lower interest rates, or additional incentives for signing up or purchasing. Another organization-level strategy directive may relate to improving profitability of an existing market share, which may guide the generation of user updates with higher prices, higher interest rates, or reduced incentives for signing up or purchasing.

The term “user analysis model” may refer to a model that is configured process a set of context-based testing scenario data to generate user update events, together with associated parameters, hyperparameters, and/or stored operations of the model. In some embodiments, the user analysis model is a trained machine learning model. In particular, the user analysis model may be a neural network (e.g., feedforward artificial neural network (ANN), multilayer perceptron (MLP), attention-based models, etc.) and/or a classification machine learning model (e.g., random forest, etc.). The user analysis model may be trained based at least in part on historical user data and/or user recommendation data. In some embodiments, the user analysis model may be a hybrid model which uses both machine learning model techniques and rules-based model techniques. For example, the user analysis model may be configured to evaluate whether given user update is compatible with rules or requirements by a particular embodiment. If the user analysis model identifies one or more incompatibilities or inferred mismatches between given context-based testing scenario data and a requirement for the embodiment, the user analysis model may generate context-based testing scenarios that address the mismatch between the current configuration and the required configuration as required by the embodiment, either via machine learning techniques or via a rules-based model.

The term “update event” may refer to a data structure comprising information related to a discrete change in conditions that may impact the identification of recommended user updates for a user. The update event may be related to personal data of the user, or may be external to the user, such as regional, national, or global events. In some embodiments, the update event may contain limited information about the triggering event itself. In some embodiments, the detection of the update event may trigger certain operations of the example embodiment. In some embodiments the update event may comprise metadata relating to the circumstances and conditions of the triggering event and/or data about the update event itself.

The term “real-time event data” may refer to any individual or aggregated data structure that may trigger an update event, as described above. Real-time event data may comprise data that is personal to the user (e.g., data which may be similar in nature to historical user data), regional, national, or global in scale. The real-time data may be collected and made available using an example method on a relatively short time scale, as opposed to collected historical data. The real-time event data may relate to a wide variety of activities including economic trends, customer preferences, current events which may impact financial activities, or the like. For example, real-time event data may include a major news report concerning market trends that may trigger an update event if the user is known to trade in the markets that are reported on in the news report.

The term “recommended update category” may refer to a classification of recommended updates that may be determined based on real-time data. A recommended update category may comprise various user updates, and the update category and/or the user updates within the categories may comprise various configurable parameters, described below. For example, recommendation categories may include new payment cards, updates to existing financial portfolios, adding new services, cancelling existing service, updates to existing payment cards, or the like.

The term “bespoke update parameter” may refer to a configurable parameter of a recommended update category and/or recommended user update. In some embodiments, the recommended update category may be combined with one or more bespoke update parameters to produce a single recommended user update. Bespoke update parameters may comprise various forms of data, including text, numerical values, images, sound, or the like. For example, a recommended user update may be a new payment card. The bespoke update parameters corresponding to the new payment card recommended user update may include a particular interest rate, a particular credit limit, a particular image printed on the card, a particular rate of earning rewards program points, and the like. The corresponding recommended update categories may correspond to the example bespoke update parameters, for example, an interest rate, a credit limit, an image to be printed on a payment card, a rate of earning rewards program points, and the like. The bespoke update parameters may be configured to be hyper-personalized to a particular user's individual data at a particular time, and as such a set of bespoke update parameters may correspond to a recommended user update that is entirely new, having not existed as a recommended user update prior to the generation of the corresponding bespoke update parameters.

### System Architecture

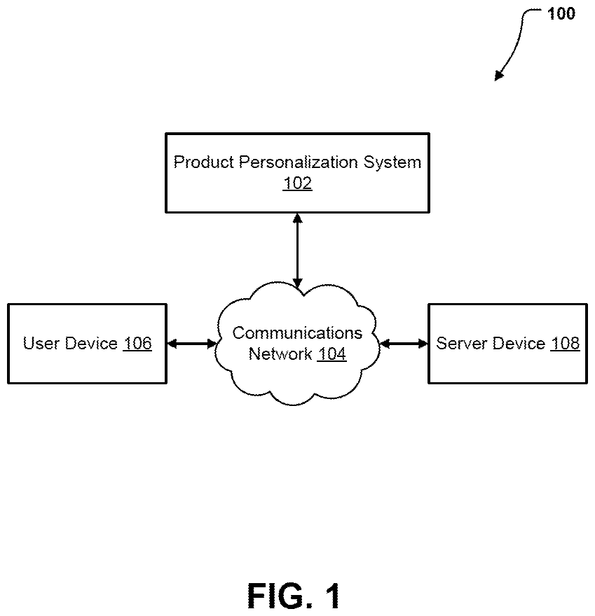

Example embodiments described herein may be implemented using any of a variety of computing devices or servers. To this end, FIG. 1 illustrates an example environment 100 within which various embodiments may operate. As illustrated, a product personalization system 102 may receive and/or transmit information via communications network 104 (e.g., the Internet) with any number of other devices, such as one or more of the depicted user device 106 and/or server device 108.

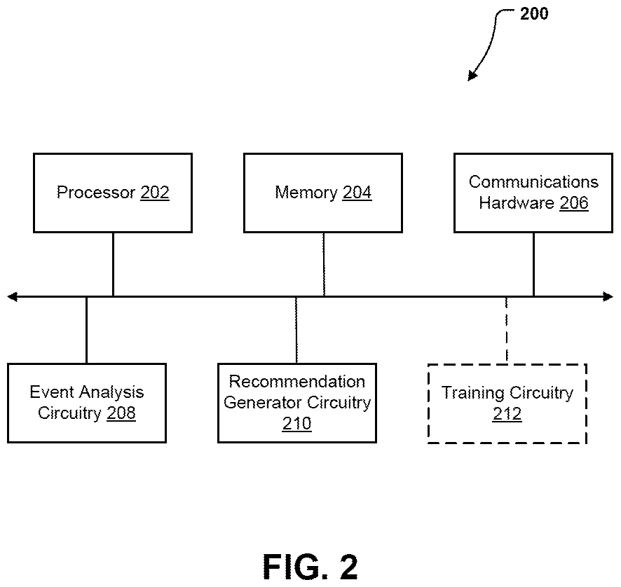

The product personalization system 102 may be implemented as one or more computing devices or servers, which may be composed of a series of components. Particular components of the product personalization system 102 are described in greater detail below with reference to apparatus 200 in connection with FIG. 2.

The user device 106 and the server device 108 may be embodied by any computing devices known in the art. The user device 106 and the server device 108 need not themselves be independent devices, but may be peripheral devices communicatively coupled to other computing devices.

Although FIG. 1 illustrates an environment and implementation in which the product personalization system 102 interacts indirectly with a user via a user device 106 or a server device 108, in some embodiments users may directly interact with the product personalization system 102 (e.g., via communications hardware of the product personalization system 102), in which case a separate BBB 106A-106N and/or CCC 108A-108N may not be utilized. Whether by way of direct interaction or indirect interaction via another device, a user may communicate with, operate, control, modify, or otherwise interact with the product personalization system 102 to perform the various functions and achieve the various benefits described herein.

### Example Implementing Apparatuses

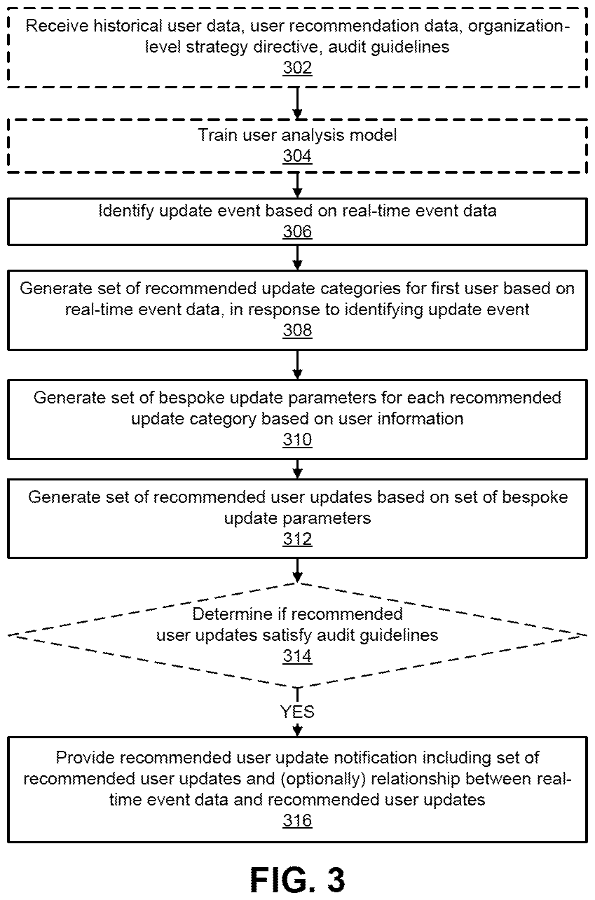

The product personalization system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIG. 3. As illustrated in FIG. 2, the apparatus 200 may include processor 202, memory 204, communications hardware 206, event analysis circuitry 208, recommendation generator circuitry 210, and training circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an event analysis circuitry 208 that identifies update events from real-time event data. The event analysis circuitry 208 may utilize processor 202, memory 204, or any other hardware component included in the apparatus 200 to perform these operations, as described in connection with FIG. 3 below. The event analysis circuitry 208 may further utilize communications hardware 206 to gather data from a variety of sources (e.g., user device 106 or server device 108, as shown in FIG. 1), and/or exchange data with a user, and in some embodiments may utilize processor 202 and/or memory 204 to identify update events.

In addition, the apparatus 200 further comprises a recommendation generator circuitry 210 that generates recommended update categories, bespoke update parameters, and recommended user updates. The recommendation generator circuitry 210 may utilize processor 202, memory 204, event analysis circuitry 208, or any other hardware component included in the apparatus 200 to perform these operations, as described in connection with FIG. 3 below. The recommendation generator circuitry 210 may further utilize communications hardware 206 to gather data from a variety of sources (e.g., user device 106 and/or server device 108, as shown in FIG. 1), and/or exchange data with a user, and in some embodiments may utilize processor 202 and/or memory 204 to generate recommendations.

Further, the apparatus 200 further comprises a training circuitry 212 that trains a user analysis model based on historical user data and user recommendation data. The training circuitry 212 may utilize processor 202, memory 204, or any other hardware component included in the apparatus 200 to perform these operations, as described in connection with FIG. 3 below. The training circuitry 212 may further utilize communications hardware 206 to gather data from a variety of sources (e.g., user device 106 and/or server device 108, as shown in FIG. 1), and/or exchange data with a user, and in some embodiments may utilize processor 202 and/or memory 204 to train the user analysis model.

Although components 202-212 are described in part using functional language, it will be understood that the particular implementations necessarily include the use of particular hardware. It should also be understood that certain of these components 202-212 may include similar or common hardware. For example, the event analysis circuitry 208, recommendation generator circuitry 210, and training circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the event analysis circuitry 208, recommendation generator circuitry 210, and training circuitry 212 may leverage processor 202, memory 204, or communications hardware 206 as described above, it will be understood that any of event analysis circuitry 208, recommendation generator circuitry 210, and training circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that event analysis circuitry 208, recommendation generator circuitry 210, and training circuitry 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

Turning to FIG. 3, example flowcharts are illustrated that contain example operations implemented by example embodiments described herein. The operations illustrated in FIG. 3 may, for example, be performed by the product personalization system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, event analysis circuitry 208, recommendation generator circuitry 210, training circuitry 212, and/or any combination thereof. It will be understood that user interaction with the product personalization system 102 may occur directly via communications hardware 206, or may instead be facilitated by a separate user device 106, as shown in FIG. 1, and which may have similar or equivalent physical componentry facilitating such user interaction.

Turning to FIG. 3, example operations are shown for generating update parameters personalized to a user. As shown by operation 302, the apparatus 200 may include means, such as processor 202, memory 204, communications hardware 206, or the like, for receiving historical user data and user recommendation data. The historical user data may be a data structure that is configured to describe data related to a particular user. In some embodiments, historical user data may include one or more of user browsing history, user location data history, user interactions with application prompts, or other historical user data. Historical user data may be directly collected from various applications or sites that may share data with the system, or may be obtained from shared info from a third party, accessed on a storage device either locally from or on a remote server. Historical user data may be usable for deriving information about a user's preferences for shopping, banking, or other activities relevant to the system, and may be analyzed to infer products or user updates for the user. For example, a user may communicate via social media that they have received a check in the mail, and plan to cash the check at a physical location. This activity may generate historical user data, which may be a derived form of the raw data from the social media interaction. This example historical user data may allow the system to infer the user conducts business using checks with some frequency and recommend user updates related to checking accordingly.

The user recommendation data may be a data structure that is configured to describe data related to a set of possible user updates that may be offered. In some embodiments, the user recommendation data may refer to past or existing user updates offered by a business or institution. For example, when configured to generate payment card user recommendations, the user recommendation data may refer to a set of payment card offers including details such as credit limits, rates, benefits, and other details of the payment card plans. User recommendation data may refer to actual existing user updates, user updates determined by a user which the system is configured to process, or automatically generated user updates, which may be generated by other methods or by example methods disclosed herein.

The historical user data and/or user recommendation data may have previously been stored in memory 204 of apparatus 200 as set forth in FIG. 2, or a server device 108 accessible by the apparatus 200 using communications hardware 206 or the like. In such cases, the historical user data and/or user recommendation data may be retrieved by the apparatus 200 unilaterally. However, the historical user data and/or user recommendation data may be received from a separate device with which a user interacts (e.g., user device 106), in which case the user identification indications may be received via communications hardware 206. If the user interacts directly with the apparatus 200, the historical user data and/or user recommendation data may be received via attached input devices of the communications hardware 206.

In some embodiments, the communications hardware 206 may further receive an organization-level strategy directive. The organization-level strategy directive may be a data structure that is configured to describe a set of parameters guiding the generation and/or selection of user updates offered to customers or users of an organization. The organization-level strategy directive may describe or suggest high-level goals that may be realized by individual user updates. For example, an organization-level strategy directive may relate to adjusting strategy to expanding market share, which may guide the generation of user updates with lower prices, lower interest rates, or additional incentives for signing up or purchasing. Another organization-level strategy directive may relate to improving profitability of an existing market share, which may guide the generation of user updates with higher prices, higher interest rates, or reduced incentives for signing up or purchasing.

In some embodiments, the historical user data may be related to the first user. The first user may be the same user that provides data for generating the set of recommended update categories, as described below in connection with operation 308. In some embodiments, the historical user data may be related to a cohort of users, where the first user belongs to the cohort of users. For example, the first user may have limited data available (e.g., the first user may be a new customer) and a cohort of users may be identified based on directory-level information about the first user. The historical user data may then be provided based on stored data related to the cohort of users in place of data from the first user.

As shown by operation 304, the apparatus 200 may include means, such as processor 202, memory 204, communications hardware 206, training circuitry 212, or the like, for training a user analysis model using the historical user data and the user recommendation data. The training circuitry 212 may train the user analysis model by fitting the internal parameters of the user analysis model to the inputs of the historical user data and the user recommendation data. The user analysis model may be a model that is configured process a set of context-based testing scenario data to generate user update events, together with associated parameters, hyperparameters, and/or stored operations of the model. In some embodiments, the user analysis model is a trained machine learning model. In particular, the user analysis model may be a neural network (e.g., feedforward artificial neural network (ANN), multilayer perceptron (MLP), attention-based models, etc.) and/or a classification machine learning model (e.g., random forest, etc.). The user analysis model may be trained based at least in part on historical user data and/or user recommendation data. Alternatively, the user analysis model may be a rules-based model configured to follow a defined set of rules and/or operations to generate user recommendations. In some embodiments, the user analysis model may be a hybrid model which uses both machine learning model techniques and rules-based model techniques. For example, the user analysis model may be configured to evaluate whether given user update is compatible with rules or requirements by a particular embodiment. If the user analysis model identifies one or more incompatibilities or inferred mismatches between given context-based testing scenario data and a requirement for the embodiment, the user analysis model may generate context-based testing scenarios that address the mismatch between the current configuration and the required configuration as required by the embodiment, either via machine learning techniques or via a rules-based model.

In some embodiments, the training circuitry 212 may clean, format, infill, or otherwise prepare the historical user data and/or the user recommendation data for training. The training circuitry 212 may be configured to train the user analysis model using supervised and/or unsupervised learning, may use a hybrid of both approaches, or may use training approaches with reduced levels of user supervision. The training circuitry 212 may use the entire datasets of the historical user data and/or the user recommendation data, or may be configured to divide the data for providing diagnostics, to control for overtraining, or for other reasons. In some embodiments, the scenarios of the historical user data and/or the user recommendation data may be interpreted and formatted as testing scenarios readable by the training circuitry 212 for testing an application.

As shown by operation 306, the apparatus 200 includes means, such as processor 202, memory 204, communications hardware 206, event analysis circuitry 208, or the like, for identifying, using an event analysis model, an update event. In some embodiments, the update event may pertain to a first user. In some embodiments, the identification may be based on the real-time even data. The update event may be a data structure comprising information related to a discrete change in conditions that may impact the identification of recommended user updates for a user. The update event may be related to personal data of the user, or may be external to the user, such as regional, national, or global events. In some embodiments, the update event may contain limited information about the triggering event itself. In some embodiments, the detection of the update event may trigger certain operations of the example embodiment. In some embodiments the update event may comprise metadata relating to the circumstances and conditions of the triggering event and/or data about the update event itself.

The real-time event data be any individual or aggregated data structure that may trigger an update event, as described above. Real-time event data may comprise data that is personal to the user (e.g., data which may be similar in nature to historical user data), regional, national, or global in scale. The real-time data may be collected and made available using an example method on a relatively short time scale, as opposed to collected historical data. The real-time event data may relate to a wide variety of activities including economic trends, customer preferences, current events which may impact financial activities, or the like. For example, real-time event data may include a major news report concerning market trends that may trigger an update event if the user is known to trade in the markets that are reported on in the news report.

In some embodiments, the real-time event data includes personal event data, general event data, or a combination thereof. The general data may include regional, national, or global event data, as described previously. In some embodiments, the real-time event data may be marked as containing two streams of data, a stream of personal event data, and a stream of general event data. The general event data may include publicly available data or data available to an organization.

The event analysis circuitry 208 may process the real-time event data by receiving real-time event data from any of a number of sources, which may be received via the communications hardware 206, from a remote server device 108, or otherwise received via the communications network 104. The event analysis circuitry 208 may identify the update event by filtering or otherwise processing the real-time event data to identify events relevant to the first user. The determination of relevance to the first user may depend on configuration of the product personalization system 102 directly by the first user, or may be inferred from collected historical user data (described above in connection with operation 302).

As shown by operation 308, the apparatus 200 includes means, such as processor 202, memory 204, communications hardware 206, recommendation generator circuitry 210, or the like, for generating, using a recommendation generation model, a set of recommended update categories for the first user. The recommendation generator circuitry 210 may generate the set of recommended update categories for the first user in response to identifying an update event (e.g., as described in connection with operation 306, the event analysis circuitry 208 may identify the update event). In some embodiments, generating the set of recommended update categories may be based on the real-time event data. The recommended update category may be a classification of recommended updates that may be determined based on real-time data. A recommended update category may comprise various user updates, and the update category and/or the user updates within the categories may comprise various configurable parameters, (described below in connection with operation 310). For example, recommendation categories may include new payment cards, updates to existing financial portfolios, adding new services, cancelling existing service, updates to existing payment cards, or the like.

The recommendation generator circuitry 210 may generate the set of recommended update categories by analyzing the real-time event data. In some embodiments, a rules-based model may be used. For example, certain categories of real-time event data may map directly to certain recommended update categories. In some embodiments, more complex models, such as supervised or unsupervised machine learning models, may be used to determine the set of recommended update categories based on the real-time event data.

As shown by operation 310, the apparatus 200 includes means, such as processor 202, memory 204, communications hardware 206, recommendation generator circuitry 210, or the like, for generating, using a user analysis model, a set of bespoke update parameters for each recommended update category in the set of recommended update categories. In some embodiments, generating the set of bespoke update parameters may be based on user information associated with the first user. The bespoke update parameter may be a configurable parameter of a recommended update category and/or recommended user update. In some embodiments, the recommended update category may be combined with one or more bespoke update parameters to produce a single recommended user update. Bespoke update parameters may comprise various forms of data, including text, numerical values, images, sound, or the like. For example, a recommended user update may be a new payment card. The bespoke update parameters corresponding to the new payment card recommended user update may include a particular interest rate, a particular credit limit, a particular image printed on the card, a particular rate of earning rewards program points, and the like. The corresponding recommended update categories may correspond to the example bespoke update parameters, for example, an interest rate, a credit limit, an image to be printed on a payment card, a rate of earning rewards program points, or the like.

The communications hardware 206 may receive user information associated with the first user and pass the information to the recommendation generator circuitry 210 for generating the set of bespoke update parameters. The recommendation generator circuitry 210 may generate one or more bespoke update parameters for each recommended update category generated, for example, in operation 308. For example, the recommendation generator circuitry 210 may receive the recommended update category indicating a payment card is to be recommended. The recommendation generator circuitry 210 may further receive information that the first user has a credit score allowing for a range of credit limits and interest rates. The recommendation generator circuitry 210 may use the received information to select, for example, three particular interest rate and credit limit combinations by selecting the sets of bespoke update parameters.

As shown by operation 312, the apparatus 200 includes means, such as processor 202, memory 204, communications hardware 206, recommendation generator circuitry 210, or the like, for generating the set of recommended user updates for the first user based on the set of bespoke update parameters. In some embodiments, each recommended user update from the set of recommended user updates may correspond to a recommended update category in the set of recommended update categories. The recommendation generator circuitry 210 may combine the bespoke update parameters obtained, for example, in operation 310, with the recommended update categories generated, for example, in operation 308, to generate the set of recommended user updates. For example, the recommendation generator circuitry 210 may generate a number of particular interest rates and credit limits for a payment card update category. The recommendation generator circuitry 210 may combine the example interest rates and credit limits to generate individual particular payment card offers, in this example. In some embodiments, the recommendation generator circuitry 210 may generate the recommended user updates in accordance with the organization-level strategy directive obtained in example operation 302.

As described previously, in some embodiments, the set of recommended user updates may include a payment card offer. The payment card offer may include, for example, a credit limit, an interest rate, a rewards program, and other details. The rewards program may include a further set of update parameters, including the conditions for earning points, ways that points may be redeemed, and any fees associated with the rewards program, for example. In some embodiments, the payment card offer may include personalized payment card graphics. The payment card graphics may be selected based on data related to the first user. For example, the data related to the first user may include information about the user's favorite animal, which may be selected as the graphics used for the payment card. In some embodiments, certain parameters may be fixed by the user update, and certain parameters may be configurable by the first user after the user update is presented. For example, the first user may configure the graphics used for the payment card, but the credit limit may be fixed and not configurable.

In some embodiments, the payment card offer may include a charitable donation agreement. The charitable donation agreement may be based on using the payment card offer. For example, a payment card may offer a percentage of purchases made at particular vendors as a charitable donation to a particular non-profit organization or other charitable cause. Parameters of the charitable donation agreement, such as the value of the percentage of purchases offered, the set of vendors eligible, and the identity of the charitable cause may be bespoke update parameters, generated, for example, in connection with operation 310. In some embodiments, the payment card offer may include a benefit unlocked by using the charitable donation agreement. For example, a payment card may display a badge or other graphic indicating a special status of the cardholder. The badge may be unlocked by using the charitable donation option of the payment card plan, and causing the contribution of a dollar amount above a particular threshold. The badge or other display graphic may indicate the level of charitable giving that was caused, the charitable cause to which the donation was sent, or other information of the like.

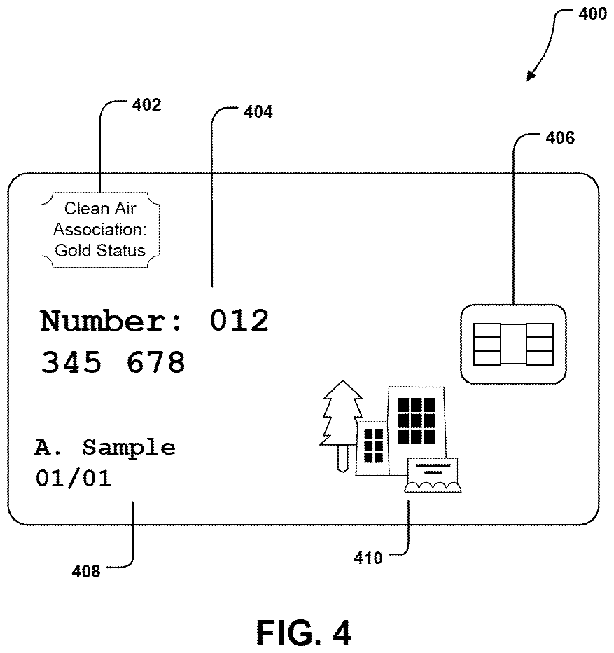

Turning to FIG. 4, an example payment card 400 that may be offered as part of a recommended user update is depicted. The payment card includes a badge 402 related to a charitable donation agreement. The payment card also includes a custom user graphic 410. The badge 402 and custom user graphic 410 may be configured by the product personalization system 102 and hyper-personalized according to the inferred preferences of the first user, as described previously. Additionally, the payment card may include various non-configurable elements, such as the card number 404, payment card chip 406, and name/expiration date 408. While the elements 404-408 may be unique to the user, they may not necessarily be varied depending on real-time event data, historical user data, or other inputs to the product personalization system 102.

In some embodiments, the communications hardware 206 may additionally receive audit guidelines. The audit guidelines may provide limitations on the set of recommended user updates. For example, the audit guidelines may provide a floor or ceiling on interest rates or reward benefit rates to offer customers as part of a payment card plan of a recommended user update.

In some embodiments, the apparatus 200 may include means, such as processor 200, recommendation generator circuitry 210 or the like, for determining if the set of recommended user updates satisfies the audit guidelines. The recommendation generator circuitry 210 may apply the audit guidelines to one or more of the recommended user updates from the set of recommended user updates. In some embodiments, the audit guidelines may be applied as a rules-based procedure, such as a decision tree, for deciding whether a recommended user update satisfies the audit guidelines.

As shown by operation 314, the apparatus 200 may include means, such as processor 202, memory 204, recommendation generator circuitry 210, or the like, for, in an instance in which a recommended user update from the set of recommended user updates satisfies the audit guidelines, allowing the recommended user update to be included in the recommended user update notification. For example, a recommended user update may offer an abnormally high cash back reward as part of a payment card benefit program. The recommendation generator circuitry 210 may use, for example, a rules-based determination by comparing the recommended user update to the audit guidelines and make a determination that the large cash back reward of the recommended user update is outside the boundaries of the audit guidelines, and reject the recommended user update. In an instance in which the recommended user update is rejected for failing to satisfy the audit guidelines, the recommended user update may not be presented to the user as part of the recommended user update notification.

Finally, as shown by operation 316, the apparatus 200 includes means, such as processor 202, memory 204, communications hardware 206, or the like, for providing a recommended user update notification comprising the set of recommended user updates. The communications hardware 206 may display the recommended user update notification, transmit the recommended user update notification to a user device 106, or otherwise provide the user update notification to the user. In some embodiments, the processor 202 may organize the recommended user update notification and/or collect several recommendations, in an instance where additional recommended user updates are provided, and present them in an organized manner to the user. In some embodiments, a graphical user interface may be presented allowing the user to review the details of each recommended user update.

In some embodiments, the communications hardware 206 may further provide the real-time event data to the user, and may also provide a relationship between the real-time event data and the set of recommended user updates. The recommendation generator circuitry 210 may track the relationship, for example, through operations 306 through 312 to determine the relationship between the real-time event data and the set of recommended user updates. For example, the operation 310 may determine that presenting to the user a set of new credit card offers may have been related to and/or caused a change in central bank interest rates. The communications hardware 206 may present the determined relationship to the user. In some embodiments, the relationship may be presented together with the recommended user update notification comprising the set of recommended user updates. The relationship may be presented using the same graphical user interface, providing additional information to the user and augmenting the presented recommended user updates. In some embodiments, the recommended user update notification may only include recommended user updates that are determined to satisfy the audit guidelines, which may be determined in operation 314.

FIG. 3 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable hyper-personalized recommendations using GAL. Example embodiments thus provide tools that overcome the problems faced by entities that seek to provide personalized products, services, and updates to customers at reduced cost. Additionally, embodiments described herein allow a wider variety of products, services, and updates to be delivered, and these may be delivered in a timely manner, following relevant events in real time.

As these examples all illustrate, example embodiments contemplated herein provide technical solutions that solve real-world problems faced while developing products, services, and updates of products or services for customers in the financial technology enabled service industry. While developing personalized recommendations for customers has been a long-standing issue in financial services, recent developments in GAI have enabled the new solutions disclosed herein. Furthermore, the increasing ubiquity of GAI and its rapidly growing applications have enabled the development of this technology, and allowed its use for the advancement of financial enabled services.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing a set of recommended user updates, the method comprising:
identifying, by event analysis circuitry and using an event analysis model, an update event pertaining to a first user based on real-time event data;
in response to identifying the update event, generating, by recommendation generator circuitry, using a recommendation generation model, and based on the real-time event data, a set of recommended update categories for the first user;
generating, by the recommendation generator circuitry, using a user analysis model, and based on user information associated with the first user, a set of bespoke update parameters for each recommended update category in the set of recommended update categories;
generating, by the recommendation generator circuitry, the set of recommended user updates for the first user based on the set of bespoke update parameters, wherein each recommended user update from the set of recommended user updates corresponds to a recommended update category in the set of recommended update categories; and
providing, by communications hardware, a recommended user update notification comprising the set of recommended user updates.

2. The method of claim 1, wherein the set of recommended user updates includes a payment card offer.

3. The method of claim 2, wherein the payment card offer comprises personalized payment card graphics.

4. The method of claim 2, wherein the payment card offer comprises a charitable donation agreement, wherein the charitable donation agreement is based on using the payment card offer.

5. The method of claim 4, wherein the payment card offer comprises a benefit unlocked by using the charitable donation agreement.

6. The method of claim 1, wherein the real-time event data comprises:
personal event data;
general event data; or
a combination thereof.

7. The method of claim 1, further comprising:
providing, by the communications hardware and to the first user, the real-time event data and a relationship between the real-time event data and the set of recommended user updates.

8. The method of claim 1, further comprising:
receiving, by the communications hardware, an organization-level strategy directive;
wherein the set of recommended user updates is further based on the organization-level strategy directive.

9. The method of claim 1, further comprising:
receiving, by the communications hardware, historical user data and user recommendation data; and
training, by training circuitry, the user analysis model using the historical user data and the user recommendation data.

10. The method of claim 9, wherein the historical user data is related to the first user.

11. The method of claim 9, wherein the historical user data is related to a cohort of users, wherein the first user belongs to the cohort of users.

12. The method of claim 1, further comprising:
receiving, by the communications hardware, audit guidelines, wherein the audit guidelines provide limitations on the set of recommended user updates; and
in an instance in which a recommended user update from the set of recommended user updates satisfies the audit guidelines, allowing, by the recommendation generator circuitry, the recommended user update to be included in the recommended user update notification.

13. The method of claim 1, wherein the update event occurs at a first time, the recommended user update notification is provided at a second time, and the first time and the second time lie within a pre-configured time window.

14. An apparatus for providing a set of recommended user updates, the apparatus comprising:
event analysis circuitry configured to identify, using an event analysis model, an update event pertaining to a first user based on real-time event data;
recommendation generator circuitry configured to:
in response to identifying the update event, generate, using a recommendation generation model and based on the real-time event data, a set of recommended update categories for the first user,
generate, using a user analysis model and based on user information associated with the first user, a set of bespoke update parameters for each recommended update category in the set of recommended update categories, and
generate the set of recommended user updates for the first user based on the set of bespoke update parameters, wherein each recommended user update from the set of recommended user updates corresponds to a recommended update category in the set of recommended update categories; and
communications hardware configured to provide a recommended user update notification comprising the set of recommended user updates.

15. The apparatus of claim 14, wherein the set of recommended user updates includes a payment card offer.

16. The apparatus of claim 14, wherein the real-time event data comprises:
personal event data;
general event data; or
a combination thereof.

17. The apparatus of claim 14, wherein the communications hardware is further configured to provide, to the first user, the real-time event data and a relationship between the real-time event data and the set of recommended user updates.

18. The apparatus of claim 14, wherein the communications hardware is further configured to receive an organization-level strategy directive, wherein the set of recommended user updates is further based on the organization-level strategy directive.

19. The apparatus of claim 14,
wherein the communications hardware is further configured to receive historical user data and user recommendation data,
wherein the apparatus further comprises training circuitry configured to train the user analysis model using the historical user data and the user recommendation data.

20. An apparatus for providing a set of recommended user updates, the apparatus comprising:
means for identifying, using an event analysis model, an update event pertaining to a first user based on real-time event data;
means for, in response to identifying the update event, generating, using a recommendation generation model and based on the real-time event data, a set of recommended update categories for the first user;
means for generating, using a user analysis model and based on user information associated with the first user, a set of bespoke update parameters for each recommended update category in the set of recommended update categories;
means for generating the set of recommended user updates for the first user based on the set of bespoke update parameters, wherein each recommended user update from the set of recommended user updates corresponds to a recommended update category in the set of recommended update categories; and
means for providing a recommended user update notification comprising the set of recommended user updates.
